(19) United States
(12) Patent Application Publication
(10) Pub. No.: US 2015/0315076 A1
(43) Pub. Date: Nov. 5, 2015

(54) COMPOSITION OF CELLULOSE ETHER AND GLUCONATE SALTS FOR USE IN CEMENT CONTAINING SKIM COATS

(71) Applicant: Dow Global Technologies LLC, Midland, MI (US)

(72) Inventor: Jian Li, Shanghai (CN)

(21) Appl. No.: 14/651,697

(22) PCT Filed: Dec. 14, 2012
(86) PCT No.: PCT/CN2012/086621

§ 371 Date: Jun. 12, 2015

(51) Int. Cl. C04B 24/38; C04B 24/26; C04B 14/28; C04B 16/00

(52) U.S. Cl. CPC C04B 24/386; C04B 16/00; C04B 24/38; C04B 24/2623; C04B 14/28

(57) ABSTRACT

This invention provides a composition of cellulose ether and gluconate salts for use in cement containing skim coat, wherein upon application of said composition, said cement containing skim coat has a pot life of no less than 2 hours and setting time no more than 20% longer than if no gluconate salt is added. In particular, said composition comprises, by weight of total solids of said skim coat, 0.2-0.6 wt. % hydroxyethyl methyl cellulose ether and 0.02-0.07 wt. % gluconate salt.

### FIELD

This invention relates to a composition of cellulose ether and gluconate salts for use in cement containing skim coats.

### BACKGROUND

A skim coat is a thin layer mortar, normally less than 3 mm, applied on either a concrete substrate or a render—a layer of mortar with thickness typically of around 15 mm applied on concrete to obtain an even surface—to create a smooth surface. Skim coats are popular in the Asia Pacific region. Dry mix skim coat compositions usually comprise of inorganic binder, fillers and additives such as water retention agents. Cement, particularly white cement, is one of the most popular inorganic binders used in skim coats. Compared with other inorganic binders such as gypsum or lime, cement has better water resistance and consistency, which makes cement containing skim coat compositions suitable for both interior and exterior applications. Gypsum containing skim coat materials set quickly, usually within minutes, making the use of setting retarders necessary to make application feasible. Lime containing skim coat usually has a long pot life, sometimes lasting overnight.

Cellulose ethers are widely used in skim coats as a water retention agent and rheology modifier, and are shown to extend the setting time for skim coats in some applications. Cellulose ethers are usually used in small qualities due to their high cost. Gluconate salts are commonly used as a setting retarder. Other commonly used setting retarders include citric acid, sodium hexametaphosphate, and bone glues. Compared with gypsum containing or lime containing skim coats, cement containing skim coats usually set in hours instead of minutes, thus normally not requiring the use of setting retarders.

However, cement containing skim coats, with their fine-sized cement particles, usually have poor pot life, that is, their viscosity increases significantly within 2 hours of preparation by mixing dry mix skim coat compositions with water, the time usually needed to keep viscosity low while skim coats are transported within and/or between work sites and until applied onto a concrete substrate or a render to make wall surfaces. Adding economically feasible small qualities of cellulose ethers often fails to sufficiently improve pot life for industrial applications. Adding setting retarders such as gluconate salts could have the downsides of lengthening the already long setting time of cement containing skim coats, resulting in longer delay and higher cost for industrial applications.

Therefore, Applicants have sought to solve the problem of providing a cement containing skim coat that has both improved pot life, i.e., no significant viscosity increase within 2 hours of preparation, and no significant lengthening of setting time.

### STATEMENT OF THE INVENTION

This invention provides a composition of cellulose ether and gluconate salts for use in cement containing skim coats which, upon application, provides a skim coat with both improved pot life and no significant lengthening of setting time. Specifically, this invention provides a composition for use in cement containing skim coat, comprising an admixture of cellulose ether and gluconate salt, wherein upon application of said composition, said cement containing skim coat has a pot life of no less than 2 hours and setting time no more than 20% longer than if no gluconate salt is added. In the composition of this invention, said cellulose ether is hydroxyethyl methyl cellulose ether, hydroxypropyl methyl cellulose ether, methyl cellulose ether, or carboxyl cellulose ether; and said gluconate salt is sodium gluconate, calcium gluconate, zinc gluconate, or ferrous gluconate. The skim coat of this invention may comprise of cement, the composition of cellulose ether and gluconate salts, and one or more of the following: a filler selected from the group consisting of calcium carbonate, dolomite, talc, silica sand, and their mixture; a redispersible latex powder or polyvinyl alcohol; or starch, starch ether, guar gum, or xanthan gum.

The term “cement” is used to refer to a binder material that, when mixed with water and sand or gravel, forms a paste that hardens slowly to form rock-hard products such as mortar or concrete. Portland cement is distinguished from other cements by the different components of which it is composed, and the requirement that it meet particular standard specifications established in each country. Portland cement is made by heating limestone (calcium carbonate) with small quantities of other materials (such as clay) to 1450° C. in a kiln, in a process known as calcination. The resulting hard substance, called “clinker”, is then ground with a small amount of gypsum into a powder to make “Ordinary Portland Cement”, the most commonly used type of cement. Portland cement may be gray or white. White Ordinary Portland Cement, or white cement, is similar to ordinary gray Portland cement, also known as gray cement, in all respects except for its high degree of whiteness. Obtaining this white color requires substantial modification to the method of manufacture, and as a result, white cement is somewhat more expensive than gray cement. Gray cement, when used with pigments, produces colors that may be attractive, but are somewhat dull. With white cement, bright reds, yellows and greens can be readily produced. White cement is very popular in skim coat applications.

Cellulose ethers used herein include water-soluble alkyl cellulose and hydroxyalkyl alkyl cellulose. A typical alkyl cellulose is methyl cellulose (MC). Exemplary hydroxyalkyl alkyl celluloses include hydroxyethyl methyl cellulose (HEMC), hydroxypropyl methyl cellulose (HPMC). Carboxyl methyl cellulose (CMC) may also be used in this invention. WALOCEL™ MW 40000 PFV is a hydroxyethyl methyl cellulose (HEMC) by The Dow Chemical Company often used in skim coat applications.

Gluconic acid is a weak organic acid containing five hydroxy groups.

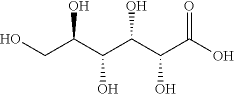 [SMILES: O=C(O)[C@H](O)[C@@H](O)[C@H](O)[C@H](O)CO]

Sodium gluconate, calcium gluconate, zinc gluconate, ferrous gluconate, etc. are important derivatives of gluconic acid. Among them, sodium gluconate is the most popular gluconate salt product. It is widely used in chemical, food, pharmaceutical, and light industries due to its excellent chelating properties. Sodium gluconate, also known as sodium pentahydroxyhexyl, is a white or light yellow crystalline powder, soluble in water, slightly soluble in alcohol, and insoluble in ether. Its formula is C₆H₁₁NaO₇, and its structure is as below.

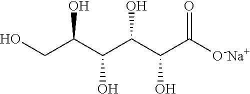

It can be made through different preparation methods such as fermentation, electrolytic oxidation, catalytic oxidation, and chemical oxidation. In concrete or skim coat applications, it is usually used as a retarding agent, or setting retarder, to extend the setting time of concrete to ensure enough time for concrete transportation and application. This retarding effect is caused by adsorption and complexion action. Too high a dosage of sodium gluconate would lead to non-setting of cement or cement containing skim coats.

Skim coat compositions often also contain fillers such as calcium carbonate, dolomite, talc, silica sand, and their mixtures, which decrease shrinkage and reduce cost in use. Additives such as starch, starch ether, guar gum, and xanthan gum may also be added to skim coats of this invention to modify rheology. Skim coats of this invention may also contain additional additives such as polyacrylamides and plasticizers which are commonly used in the construction industry.

Redispersible latex powders (RDPs) are organic polymeric powders made by spray drying aqueous latexes. RDPs are used as organic polymeric binders, together with cellulose ethers and other additives, in cement containing or gypsum containing skim coat products for the construction industry. RDPs can improve the flexural strength, tensile adhesion to various substrate, and flexibility of mortar formulations by forming a film and a network in the mortar matrix. There are different types of RDPs, among which vinyl acetate/ethylene (Va/E) copolymers are the most popular, followed by vinyl acetate/vinyl ester of versatic acid (Va/VeoVa) copolymers. Dow™ Latex Polymer (DLP) 2001, a RDP supplied by The Dow Chemical Company, is composed of Va/E and Va/VeoVa and fit for skim coat applications to confer improved tensile adhesion and water resistance. In some skim coat applications of this invention, RDPs could be substituted by polyvinyl alcohols.

In this invention, weight percentage (wt. %) is based on the total solids of the skim coats comprising the composition of cellulose ether and gluconate salts, cement, and other fillers and additives where present. In other words, 100 wt. % represent the total solids of the skim coats without water added, i.e., the total solids of the dry mix skim coats. In one aspect, the composition of this invention comprises, by weight percentage, 0.2-0.6 wt. % cellulose ether and 0.02-0.07 wt. % gluconate salt, preferably, 0.03 to 0.065 wt. % gluconate salt, in 10-35 wt. % white cement, 65-90 wt. % calcium carbonate, and 0-6 wt. % RDP. In white cement compositions, the composition of this invention comprises, by weight percentage, 0.2-0.4 wt. % cellulose ether and 0.02-0.07 wt. % gluconate salt, preferably 0.03 to 0.065 wt. % gluconate salt, in 20-30 wt. % white cement, 70-80 wt. % calcium carbonate and 1-3 wt. % RDP.

In compositions including RDP (redispersible latex powders), the composition of this invention comprises, by weight percentage, 0.2-0.6 wt. % cellulose ether and 0.02-0.07 wt. % gluconate salt in 10-35 wt. % cement, 65-90 wt. % calcium carbonate, and 0.01-6 wt. % RDP. Preferably, the composition of this invention comprises, by weight percentage, 0.3-0.4 wt. % cellulose ether and 0.02-0.04 wt. % gluconate salt in 20-30 wt. % cement, 70-80 wt. % calcium carbonate and 1-3 wt. % RDP.

This invention is further illustrated by the following examples.

### EXAMPLES

### I. Raw Materials

| Commercial name | Type | Supplier |
|---|---|---|
| Walocel ™ MW 40000 | hydroxyethyl | Dow Chemical (China) |
| PFV | methyl cellulose, | Investment Co., Ltd. |
| | a cellulose ether | |
| sodium gluconate, | | Sinopharm Chemical |
| analytical pure | | Reagent Co. Ltd. |
| white cement, PO 42.5 | inorganic binder | Shanghai White Cement |
| | | Co., Ltd. |
| calcium carbonate, 325 | filler | Guangfu Building Materials |
| mesh powder | | (Jiaoling) Fine |
| | | Chemicals Co., Ltd. |
| DLP 2001 | organic binder | Dow Chemical (China) |
| | | Investment Co., Ltd. |

### II. Examples

### Inventive Example (IE) 1-5 and Comparative Example (CE) 1-2

Walocel™ MW 40000 PFV cellulose ether with sodium gluconate were mixed in a V blender or another blending equipment to obtain a homogenous blend. The amounts of each material in the examples are shown in Table 1, below. The above blend was then mixed with other ingredients as shown in Table 1, below, for 20 min in a V blender. The final product was a homogeneous mortar or paste made with the skim coat composition of this invention.

TABLE 1

| Ingredients, | | | | | | | |
|---|---|---|---|---|---|---|---|
| wt. % unless | | | | | | | |
| otherwise specified | CE1 | CE2 | IE1 | IE2 | IE3 | IE4 | IE5 |
| Walocel ™ MW | — | 0.35 | 0.33 | 0.31 | 0.29 | 0.27 | 0.25 |
| 40000 PFV | | | | | | | |
| sodium gluconate | — | — | 0.02 | 0.04 | 0.06 | 0.08 | 0.1 |
| Cellulose ether/sodium | — | 100/0 | 94/6 | 89/11 | 83/17 | 77/23 | 71/29 |
| gluconate | | | | | | | |
| (wt. %/wt. %) | | | | | | | |
| white cement | 28 | 28 | 28 | 28 | 28 | 28 | 28 |
| calcium carbonate | 71 | 70.65 | 70.65 | 70.65 | 70.65 | 70.65 | 70.65 |
| DLP 2001 | 1 | 1 | 1 | 1 | 1 | 1 | 1 |
| Total | 100 | 100 | 100 | 100 | 100 | 100 | 100 |
| Water demand | 33 | 33 | 33 | 33 | 33 | 33 | 33 |

### III. Test Methods and Results

At a temperature of 23±2° C. and a relative humidity of 50±5%, 1-2 kg skim coat paste was mixed as described in Table 1 in a Hobart mixer. Around 400 g skim coat paste was filled in a plastic cup without any air bubble as detected by eyeballing. The skim coat paste was allowed to stay in the cup for 5 min and the viscosity of the paste at 5 rpm was tested with a T-bar spindle with Helipath™ stand on a Brookfield viscometer, Brookfield Engineering Laboratories, Inc., 11 Commerce Boulevard, Middleboro, Mass., USA. The rest of the skim coat paste was left in the mixing pot. Two (2) hours later, the skim coat was manually mixed with a spatula, and the above test procedure was repeated to determine the viscosity of the skim coat paste. Viscosity change (2 hr. vs. 0 hr.) indicated the retention of workability. If the viscosity of the skim coat paste had not increased within the 2 hour time frame, the paste's pot life had not ended. Otherwise, the pot life was over. Since a 2-hour pot life is normally required by construction workers, only viscosity at 0 hr. and 2 hr. was tested.

Vicat needle testers were used to test the setting time of the skim coat paste. The Vicat needle is cylindrical, with a 1 mm² (0.0015 in.²) cross section and moves in a vertical scaled guide, penetrating a mass of cement or skim coat paste placed in a mold. Initial set or initial setting time is defined as the time at which the needle will not penetrate past a certain distance, 25 mm (1 in.) here, from the top of the sample. Final set or final setting time is defined as the time when there will be no mark upon the surface from the needle, that is, no penetration of the needle at all. The Vicat needle test is the test most used by cement manufacturers to define setting time and is the subject of multiple standards (for example, ISO 9597 and ASTM C191) around the world. The Vicatronic Automatic Single Station Vicat Needle Apparatus (Vicatronic, 3 Route de Chateaumeillant, 18270 Culan, France) was used, at a temperature of 23±2° C. and a relative humidity of 50±5%. Initial and final setting times were read directly from the device.

The testing results are shown in Table 2 below.

TABLE 2

| Test items | CE1 | CE2 | IE1 | IE2 | IE3 | IE 4 | IE5 |
|---|---|---|---|---|---|---|---|
| Cellulose ether/sodium | — | 100/0 | 94/6 | 89/11 | 83/17 | 77/23 | 71/29 |
| gluconate | | | | | | | |
| (wt. %/wt. %) | | | | | | | |
| Viscosity, k · mpa · s, | 309 | 487 | 554 | 524 | 528 | — | — |
| 0 hr. | | | | | | | |
| Viscosity, k · mpa · s, | 730* | 582 | 429 | 403 | 387 | — | — |
| 2 hr. | | | | | | | |
| Viscosity change | 136% | 20% | −23% | −23% | −27% | — | — |
| (2 hr. vs. 0 hr.) | | | | | | | |
| Initial setting | — | 550 | 600 | 600 | 660 | 854 | 1121 |
| time, min | | | | | | | |
| Initial setting time | — | — | 9% | 9% | 20% | 55% | 104% |
| change over CE2 | | | | | | | |
| Final setting time, min | — | 650 | 720 | 750 | 750 | 1094 | 1361 |
| Final setting time | — | — | 11% | 15% | 15% | 68% | 109% |
| change over CE2 | | | | | | | |

*unstable result since it becomes inhomogeneous after 2 h.

As shown in Table 2, if neither cellulose ether or sodium gluconate was in the skim coat paste, the paste became inhomogeneous, and unworkable, after 2 hours. In comparative example 2 (CE2), when only 0.35 wt. % cellulose ether, by weight percentage of the total solids of skim coat, was added in the skim coat paste, within 2 hours viscosity increased around 20%. When a total amount of 0.35 wt. % cellulose ether/sodium gluconate blend was added in the skim coat paste (IE1-IE5), and the sodium gluconate amount changed from 0.02 wt. % to 0.06 wt. %, i.e., with the weight ratio of cellulose ether/sodium gluconate ranging from 94/6 to 83/17 (IE1-IE3), viscosity of the skim coat paste at 2 hours were effectively controlled, in fact reduced by 23% to 27%, allowing the skim coat paste to maintain a pot life for at least 2 hours. When the sodium gluconate amount was 0.02 wt. % (weight ratio of cellulose ether/sodium gluconate at 94/6) (IE1), the initial setting time of the skim coat paste increased only 9%, and the final setting time increased only 11%. When the sodium gluconate amount was 0.04 wt. % by weight of the solids (weight ratio of cellulose ether/sodium gluconate at 89/11) (IE2), the initial setting time of the skim coat paste increased only 9%, similar to IE1, and the final setting time increased only 15%, by an additional 30 minutes. When the sodium gluconate amount was 0.06 wt. % (weight ratio of cellulose ether/sodium gluconate at 83/17) (IE3), the initial setting time of the skim coat paste increased 20%, and the final setting time increased 15%. In IE1 through 1E3, neither the initial nor the final setting time was lengthened by more than 20% compared with those of the skim coat with no added gluconate salt. When the sodium gluconate amount was more than 0.07 wt. %, e.g., 0.08 wt. % (IE4) or 0.10 wt. % (IE5), both the initial and the final setting times of the skim coat paste increased drastically—55% and 68% for 1E4 vs. 104% and 109% for IE5.

Although some aspects of this invention have been described, many modifications and variations may be made thereto in light of the above teachings. It is therefore to be understood that the invention may be practiced otherwise than as specifically described without departing from the scope of the appended claims.

1. A composition for use in cement containing skim coat, comprising an admixture of:
a) cellulose ether, and
b) gluconate salt,
wherein upon application of said composition, said cement containing skim coat has a pot life of no less than 2 hours and setting time no more than 20% longer than if no gluconate salt is added.

2. A composition of claim 1, wherein:
said cellulose ether is hydroxyethyl methyl cellulose ether, hydroxypropyl methyl cellulose ether, methyl cellulose ether, or carboxyl cellulose ether; and
said gluconate salt is sodium gluconate, calcium gluconate, zinc gluconate, or ferrous gluconate.

3. A composition of claim 2, wherein:
said cellulose ether is hydroxyethyl methyl cellulose ether; and
said gluconate salt is sodium gluconate.

4. A composition of claim 1, comprising 0.2-0.6 wt. % cellulose ether and 0.02-0.07 wt. % gluconate salt by weight of total solids of said skim coat comprising said composition and cement.

5. A composition of claim 4, comprising 0.2-0.6 wt. % cellulose ether and 0.03-0.065 wt. % gluconate salt by weight of total solids of said skim coat comprising said composition and cement.

6. A composition of claim 5, comprising 0.2-0.4 wt. % hydroxyethyl methyl cellulose ether and 0.02-0.07 wt. % sodium gluconate by weight of total solids of said skim coat comprising said composition and cement.

7. A composition of claim 6, comprising 0.2-0.4 wt. % hydroxyethyl methyl cellulose ether and 0.03-0.065 wt. % sodium gluconate by weight of total solids of said skim coat comprising said composition and cement.

8. A skim coat, comprising cement, a composition of claim 1, and one or more of:
a) a filler selected from the group consisting of calcium carbonate, dolomite, talc, silica sand, and their mixture;
b) a redispersible latex powder or polyvinyl alcohol; or
c) starch, starch ether, guar gum, or xanthan gum.

9. A skim coat of claim 8, comprising by weight of the total solids of said skim coat 10-35 wt. % cement, 0.2-0.6 wt. % cellulose ether, 0.02-0.07 wt. % gluconate salt, 65-90 wt. % calcium carbonate, and 0.01-6 wt. % redispersible latex powder.

10. A skim coat of claim 9, comprising by weight of the total solids of said skim coat 20-30 wt. % cement, 0.2-0.4 wt. % cellulose ether, and 0.02-0.04 wt. % gluconate salt, 70-80 wt. % calcium carbonate, and 1-3 wt. % redispersible latex powder.
